(19) United States
(12) Patent Application Publication
(10) Pub. No.: US 2011/0174897 A1
(43) Pub. Date: Jul. 21, 2011

(54) SOLAR PANEL WATER PUMP ASSEMBLY AND METHOD

(76) Inventor: Li Zhuang Mai, Guangzhou (CN)

(21) Appl. No.: 12/690,369

(22) Filed: Jan. 20, 2010

(51) Int. Cl. B05B 17/08; B23P 11/00; F21S 8/00; F04B 17/00; F21S 9/03

(52) U.S. Cl. 239/18; 29/428; 417/423.3; 239/23

(57) ABSTRACT

A solar panel water pump assembly is provided. A solar panel apparatus includes a plurality of light-emitting diodes and is attached to a support base. The solar panel apparatus is electrically coupled to a battery cell box and a control circuit board box that are attached to a bottom side of the support base. A water conduit adapter is inserted through the solar panel apparatus and the support base via an aperture. Then, the water conduit adapter inserted through the solar panel apparatus and support base is mechanically connected to a water outlet of a pump to form the solar panel water pump assembly. The pump is electrically coupled to the control circuit board box via electrical connectors. Afterward, the solar panel water pump assembly is installed in an underwater environment in a water display.

### BACKGROUND

1. Field

The disclosure relates generally to an improved solar panel water pump assembly and more specifically to a submersible solar panel apparatus that includes a plurality of light-emitting diodes for automatically providing an underwater multi-color light display in, for example, decorative fountains, aquariums, garden pools, and the like.

2. Description of the Related Art

A solar cell or photovoltaic cell is a device that converts light directly into electricity by the photovoltaic effect. Sometimes the term solar cell is reserved for devices intended specifically to capture energy from sunlight, while the term photovoltaic cell is used when the light source is unspecified. Assemblies of these cells are used to make solar panels, solar modules, or photovoltaic arrays. These assemblies are used to generate solar energy or solar power.

When exposed to sunlight, conventional solar panels generate electrical power for devices. The use of solar panels as a source of electrical power for garden products and ornaments is known in the art. For example, connecting a solar panel to an electric water pump. However, these conventional solar panels do not include any functionality other than producing electrical energy.

### SUMMARY

According to one embodiment of the present invention, a solar panel water pump assembly is assembled. The solar panel water pump assembly includes a solar panel apparatus that includes a plurality of light-emitting diodes that is attached to a support base. The solar panel apparatus with the plurality of light-emitting diodes is electrically coupled to a battery cell box and a control circuit board box that are attached to a bottom side of the support base. A water conduit adapter is inserted through the solar panel apparatus with the plurality of light-emitting diodes and the support base via an aperture. Then, the water conduit adapter inserted through the solar panel apparatus and support base is mechanically connected to a water outlet of a pump to form the solar panel water pump assembly. The pump is electrically coupled to the control circuit board box via electrical connectors. Afterward, the solar panel water pump assembly is installed in an underwater environment in a water display.

### BRIEF DESCRIPTION OF THE SEVERAL VIEWS OF THE DRAWINGS

FIG. 1 is a pictorial representation of an exploded perspective view of a solar panel water pump assembly in accordance with an illustrative embodiment;

FIG. 2 is a pictorial representation of a top perspective view of the solar panel water pump assembly in accordance with an illustrative embodiment;

FIG. 3 is a pictorial representation of a bottom perspective view of the solar panel water pump assembly in accordance with an illustrative embodiment;

FIG. 4 is an exemplary illustration of the electrical principles of the solar panel water pump assembly in accordance with an illustrative embodiment; and

FIG. 5 is a flowchart illustrating an exemplary process for assembling a solar panel water pump assembly in accordance with an illustrative embodiment.

### DETAILED DESCRIPTION

In the following detailed description of illustrative embodiments of the present invention, reference is made to the accompanying drawings that form a part hereof, and in which is shown by way of illustration specific illustrative embodiments in which the present invention may be practiced. These illustrative embodiments are described in sufficient detail to enable those skilled in the art to practice the present invention, and it is understood that other embodiments may be utilized and that logical mechanical and electrical changes may be made without departing from the scope and spirit of the present invention. To avoid detail not necessary to enable those skilled in the art to practice the present invention, the detailed description may omit certain information known to those skilled in the art. The following detailed description is, therefore, not to be taken in a limiting sense, and the scope of the present invention is defined only by the appended claims.

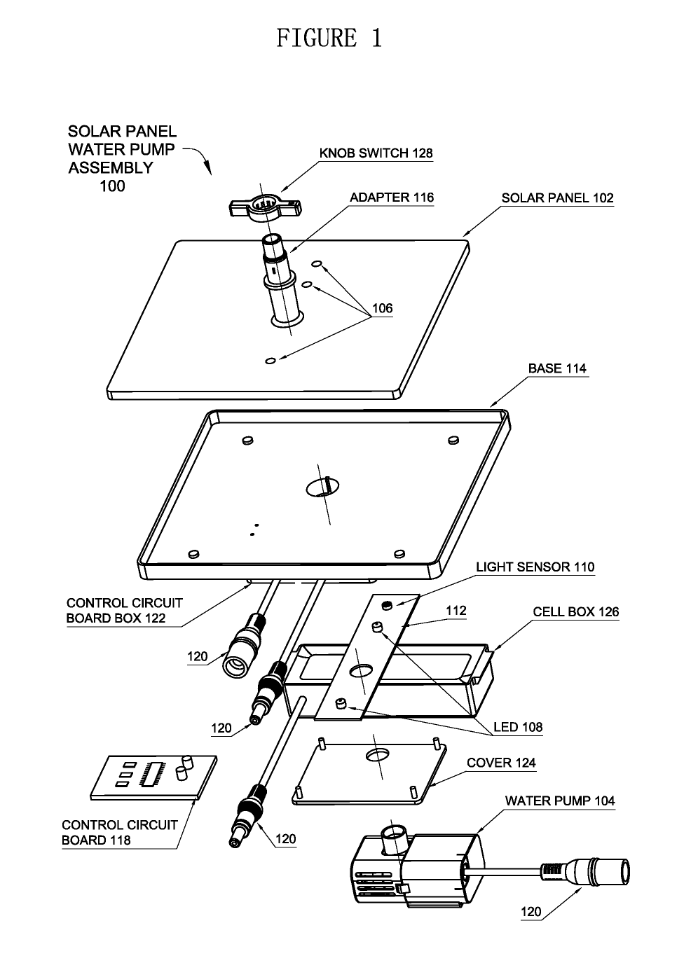

With reference now to the figures, and in particular, with reference to FIGS. 1-4, exemplary diagrams of environments are provided in which illustrative embodiments may be implemented. It should be appreciated that FIGS. 1-4 are only exemplary and are not intended to assert or imply any limitation with regard to the environments in which different embodiments may be implemented. Many modifications to the depicted environments may be made.

FIG. 1 is a pictorial representation of an exploded perspective view of a solar panel water pump assembly in accordance with an illustrative embodiment. Solar panel water pump assembly 100 is an assembly of components, which mechanically and electrically connects solar panel 102 to water pump 104. In addition, solar panel water pump assembly 100 is a submersible assembly. In other words, solar panel 102 and water pump 104 are capable of functioning properly in a submerged aqueous environment, such as an aquarium, garden pool, water fountain, or water fall.

Solar panel 102 provides electrical power to water pump 104. Water pump 104 includes an electric motor to drive an impeller to move water out of water pump 104 through a water outlet. Water pump 104 is used to re-circulate water in a water display to provide, for example, a water aeration effect, a water fountain effect, a waterfall effect, a water cascade effect, or any combination thereof, depending upon the particular environment solar panel water pump assembly 100 is placed within.

It should be noted that even though in this illustrative example solar panel 102 provides electrical power to water pump 104, illustrative embodiments are not limited to such. In other words, solar panel 102 may provide power to any type of electrical device that may be connected to it. In addition, even though solar panel 102 is shown as a single solar panel, solar panel 102 may represent one of a plurality of solar panels included in the assembly.

Solar panel 102 includes apertures 106. Apertures 106 are holes in solar panel 102 for incorporating other functionality into solar panel 102. For example, solar panel 102 integrates a plurality of light-emitting diodes (LEDs), such as LEDs 108, and a light sensor, such as light sensor 110. LEDs 108 are electronic light sources. Solar panel water pump assembly 100 uses LEDs 108 to produce an underwater light display of a plurality of different color. LEDs 108 produce light by electroluminescence and the color of the light is determined by the energy gap of the semiconductor material used to make LEDs 108.

Light sensor 110 may, for example, be a photodiode or any other device capable of detecting a predetermined level of ambient sunlight. LEDs 108 and light sensor 110 are assembled on LED circuit board 112. LED circuit board 112 is attached to the underside of solar panel 102 so that LEDs 108 and light sensor 110 are integrated into solar panel 102 via apertures 106.

Solar panel 102 with LEDs 108 and light sensor 110 is placed on the top side of base 114. Base 114 is a stable frame that provides mechanical support for solar panel 102 and LED circuit board 112. Adapter 116 is mechanically connected to base 114. Adapter 116 is a hollow conduit used for transporting water from the outlet of water pump 104 to a place above solar panel 102 to create, for example, a water fountain effect. The water fountain effect may, for example, be created by attaching a nozzle to the top of adapter 116. Adapter 116 passes through solar panel 102 via another aperture.

Solar panel 102 is electrically connected to water pump 104 via control circuit board 118 and electrical connectors 120. Control circuit board 118 provides electrical control of water pump 104. In addition, control circuit board 118 controls the light output of LEDs 108 by utilizing input from light sensor 110 to determine when to automatically power on LEDs 108 to create lighting effects. Further, control circuit board 118 may cause LEDs 108 to begin flashing on and off under poor lighting conditions.

Moreover, control circuit board 118 may include a color control unit for controlling the color output of LEDs 108. Alternatively, the color control unit may be included on LED circuit board 112. As a result, control circuit board 118 and/or LED circuit board 112 provide a beautifying function for the underwater environment in which solar panel water pump assembly 100 is submerged. Furthermore, solar panel 102 and base 114 conceal water pump 104 from view to further enhance the beauty of the environment in which solar panel water pump assembly 100 is placed.

Control circuit board 118 is placed in control circuit board box 122 and sealed with circuit box cover 124. Control circuit board box 122 is attached to the bottom side of base 114. Cell box 126 also is attached to the bottom side of base 114 and positioned adjacent to control circuit board box 122. Cell box 126 includes one or more battery cells and is electrically connected to control circuit board 118 via electrical connectors 120.

Solar panel water pump assembly 100 uses cell box 126 for electrical power storage and for electrical power output. Cell box 126 is electrically connected to solar panel 102 and stores the electrical output of solar panel 102 during periods of adequate sunlight. The electrical power output of cell box 126 may, for example, be controlled by knob switch 128. Knob switch 128 is a power on/off switch located on adapter 116. When knob switch 128 is in the on position, cell box 126 supplies electrical power to water pump 104 and LEDs 108.

However, it should be noted that light sensor 110 controls the on/off functioning of LEDs 108 according to the current light conditions. When knob switch 128 is in the off position, the electrical power supply from cell box 126 is cut off. Consequently, when knob switch 128 is in the off position, LEDs 108 will not light or flash as no electrical power is supplied to LEDs 108.

During periods of no light or poor lighting conditions or when the output voltage of solar panel 102 is lower than the battery cell voltage in cell box 126, cell box 126 supplies the electrical power to water pump 104 and LEDs 108 for their functioning. During periods of adequate lighting conditions or when the output voltage of solar panel 102 is higher than the battery cell voltage in cell box 126, solar panel 102 supplies the electrical power to water pump 104 and LEDs 108, as well as provides electrical charging to the one or more battery cells contained within cell box 126.

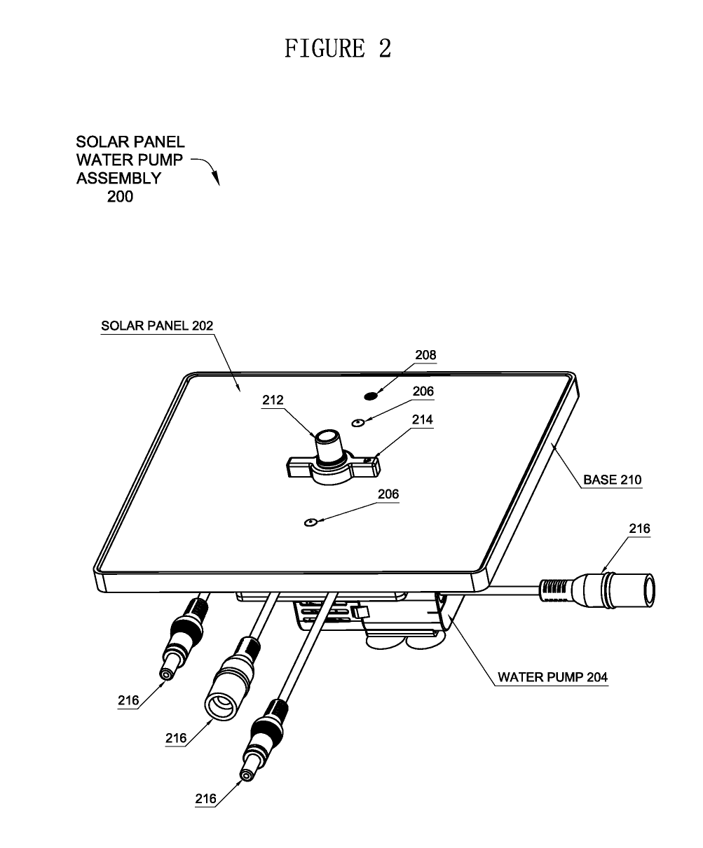

With reference now to FIG. 2, a pictorial representation of a top perspective view of the solar panel water pump assembly is depicted in accordance with an illustrative embodiment. Solar panel water pump assembly 200 may, for example, be solar panel water pump assembly 100 in FIG. 1. Solar panel water pump assembly 200 includes solar panel 202 and water pump 204, such as solar panel 102 and water pump 104 in FIG. 1. Solar panel 202 includes a plurality of LEDs, such as LEDs 206. LEDs 206 may, for example, be LEDs 108 in FIG. 1. Solar panel 202 also includes a light sensor, such as light sensor 208. Light sensor 208 may, for example, be light sensor 110 in FIG. 1. Solar panel water pump assembly 200 also includes base 210. Base 210 mechanically supports solar panel 202 with LEDs 206 and light sensor 208. Base 210 may, for example, be base 114 in FIG. 1.

Solar panel water pump assembly 200 further includes adapter 212, knob switch 214, and electrical connectors 216. Adapter 212 is mechanically connected to base 210 and to an outlet of water pump 204. Adapter 212 passes through solar panel 202 via an aperture to produce, for example, a water fountain effect above solar panel 202. Adapter 212 may, for example, be adapter 116 in FIG. 1. Knob switch 214 may, for example, be knob switch 128 in FIG. 1 and electrical connectors 216 may, for example, be electrical connectors 120 in FIG. 1.

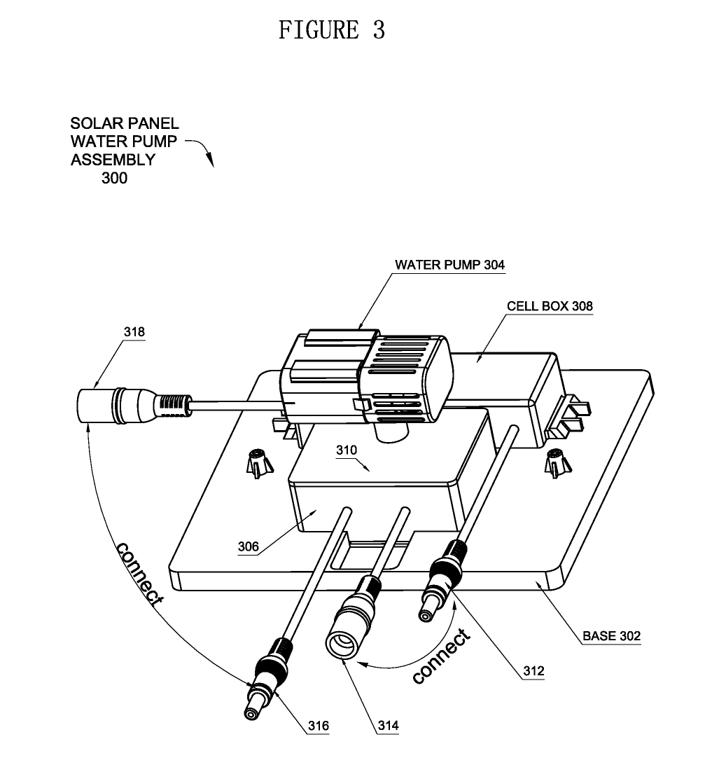

With reference now to FIG. 3, a pictorial representation of a bottom perspective view of the solar panel water pump assembly is depicted in accordance with an illustrative embodiment. Solar panel water pump assembly 300 may, for example, be solar panel water pump assembly 100 in FIG. 1. Solar panel water pump assembly 300 includes base 302 and water pump 304, such as base 114 and water pump 104 in FIG. 1. Control circuit box 306 and cell box 308 are attached to the bottom side of base 302 adjacent to one another. Control circuit box 306 and cell box 308 may, for example, be control circuit board box 122 and cell box 126 in FIG. 1.

Control circuit box 306 contains a control circuit board, such as control circuit board 118 in FIG. 1, which is sealed inside control circuit box 306 by circuit box cover 310, such as circuit box cover 124 in FIG. 1. Control circuit box 306 is electrically connected to cell box 308 via electrical connectors, such as electrical connectors 120 in FIG. 1. Cell box 308 includes output electrical connector 312. Control circuit box 306 includes input electrical connector 314 and output electrical connector 316. Water pump 304 includes input electrical connector 318. Output electrical connector 312 electrically connects cell box 308 to the control circuit board contained in control circuit box 306 via input electrical connector 314. Output electrical connector 316 electrically connects the control circuit board contained within control circuit box 306 to the electric motor contained in water pump 304 via input electrical connector 318. It should be noted that the output and input electrical connectors are removably connected to one another.

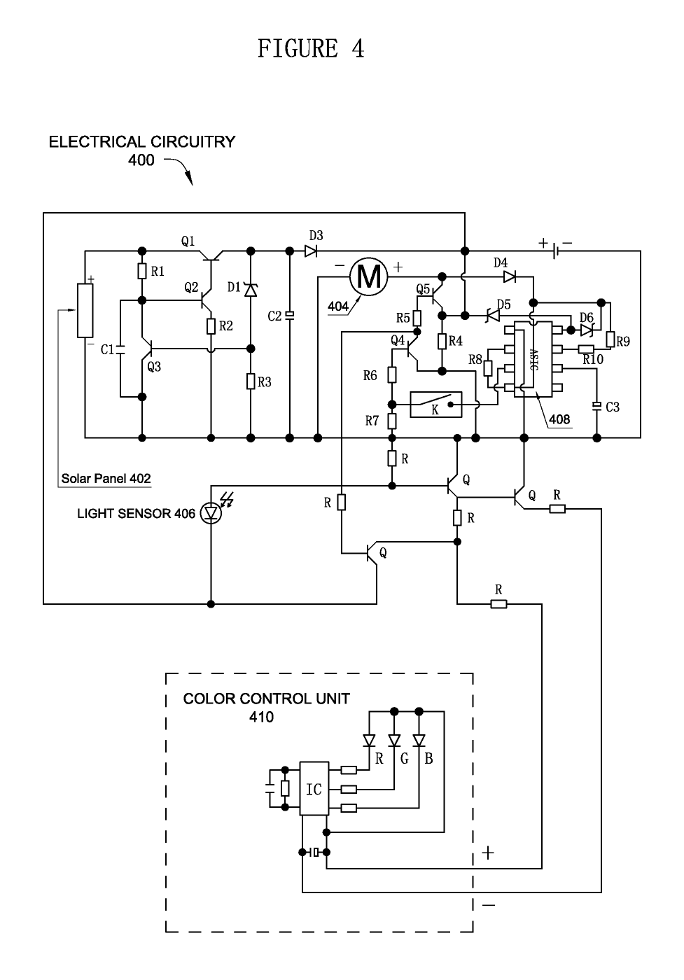

With reference now to FIG. 4, an exemplary illustration of the electrical principles of the solar panel water pump assembly is depicted in accordance with an illustrative embodiment. Electrical circuitry 400 includes electrical circuitry for solar panel 402, motor 404, and light sensor 406. Solar panel 402 may, for example, be solar panel 102 in FIG. 1. Motor 404 may, for example, be an electric motor in a water pump, such as water pump 104 in FIG. 1. Light sensor 406 may, for example be light sensor 110 in FIG. 1, which is integrated into the solar panel.

Electrical circuitry also includes application-specific integrated circuit (ASIC) 408. ASIC 408 may, for example, be control circuit board 118 in FIG. 1. ASIC 408 is an integrated circuit, which is customized for its particular use in the solar panel water pump assembly. ASIC 408 may, for example, include one or more processors and one or more storage devices, such as read only memory (ROM), random access memory (RAM), and flash memory.

Electrical circuitry 400 further includes color control unit 410. Color control unit 410 may be included on an LED circuit board, such as LED circuit board 112 in FIG. 1. Alternatively, color control unit 410 may be included on ASIC 408. Color control unit 410 is an integrated circuit that provides color output control for LEDs, such as LEDs 108 in FIG. 1, which are integrated into solar panel 402. Color control unit 410 may be programmed to provide a plurality of different color pattern outputs for creating a plurality of different underwater color displays. It should be noted that even though color control unit 410 indicates the control of primary colors red, green, and blue in the exemplary illustration, color control unit 410 may control the use of any color or combination of colors produced by the LEDs integrated into the solar panel.

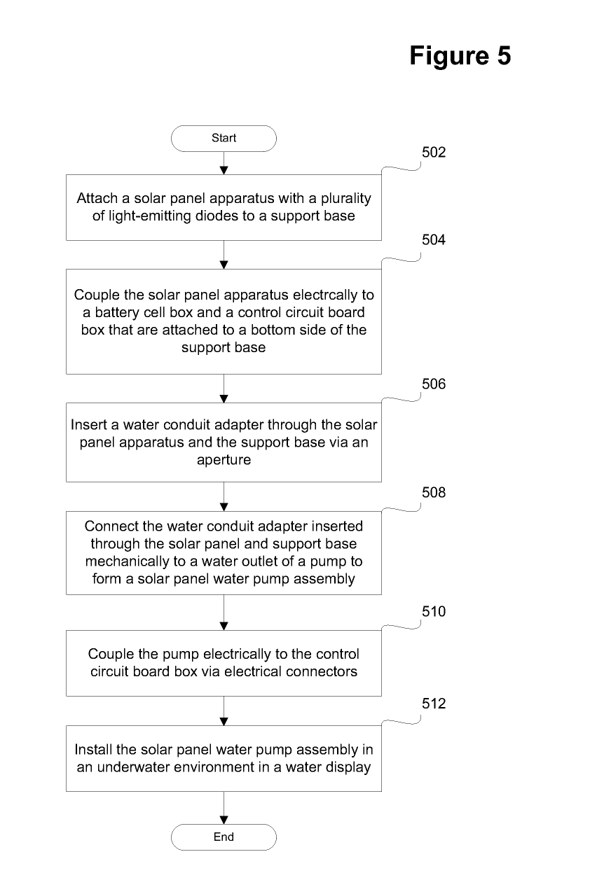

With reference now to FIG. 5, a flowchart illustrating an exemplary process for assembling a solar panel water pump assembly is shown in accordance with an illustrative embodiment. The solar panel water pump assembly may, for example, be solar panel water pump assembly 100 in FIG. 1.

The process begins when the assembler attaches a solar panel apparatus with a plurality of LEDs, such as solar panel 102 with LEDs 108 in FIG. 1, to a support base, such as base 114 in FIG. 1 (step 502). Afterward, the assembler electrically couples the solar panel apparatus to a battery cell box and a control circuit board box, such as cell box 126 and control circuit board box 122 in FIG. 1, which are attached to a bottom side of the support base adjacent to one another (step 504). Subsequently, the assembler inserts a water conduit adapter, such as adapter 116 in FIG. 1, through the solar panel apparatus and the support base via an aperture (step 506).

Then, the assembler mechanically connects the water conduit adapter inserted through the solar panel apparatus and support base to a water outlet of a pump, such as water pump 104 in FIG. 1, to form the solar panel water pump assembly (step 508). Afterward, the assembler electrically couples the pump to the control circuit board box via electrical connectors, such as output electrical connector 316 and input electrical connector 318 in FIG. 3 (step 510). Subsequently, the assembler installs the solar panel water pump assembly in an underwater environment in a water display, such as a water fountain, a waterfall, or an aquarium (step 512).

The process terminates thereafter. However, it should be noted that the assembler may perform the steps above in any order and may perform two or more steps concurrently. Also, it should be noted that the assembler may add additional parts and components to the solar panel water pump assembly at any time during the assembly process.

Thus, illustrative embodiments provide a method and apparatus for an improved submersible solar panel apparatus that includes a plurality of LEDs for creating a multi-color light display in an underwater environment. The circuits as described above are part of the design for an integrated circuit chip. The chip designs are created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting designs by physical means (e.g., by providing a copy of the storage medium storing the design) or electronically (e.g., through the Internet) to such entities, directly or indirectly. The stored designs are then converted into the appropriate format (e.g., GDSII) for the fabrication of photolithographic masks, which typically include multiple copies of the chip designs in question that are to be formed on wafers. The photolithographic masks are utilized to define areas of the wafers (and/or the layers thereon) to be etched or otherwise processed.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for assembling a solar panel water pump assembly, the method comprising:
attaching a solar panel apparatus that includes a plurality of light-emitting diodes to a support base;
coupling the solar panel apparatus electrically to a battery cell box and a control circuit board box that are attached to a bottom side of the support base;
inserting a water conduit adapter through the solar panel apparatus and the support base via an aperture;
connecting the water conduit adapter inserted through the solar panel apparatus and support base mechanically to a water outlet of a pump to form the solar panel water pump assembly;
coupling the pump electrically to the control circuit board box via electrical connectors; and
installing the solar panel water pump assembly in an underwater environment in a water display.

2. The method of claim 1, wherein the solar panel apparatus includes a plurality of solar panels.

3. The method of claim 1, wherein the solar panel apparatus includes a light sensor.

4. The method of claim 1, wherein the solar panel apparatus creates a multi-colored display in the underwater environment.

5. The method of claim 3, wherein the plurality of light-emitting diodes and the light sensor are assembled on a circuit board attached to the solar panel apparatus.

6. The method of claim 3, wherein the light sensor controls on/off functioning of the plurality of light-emitting diodes according to current light conditions.

7. The method of claim 1, wherein a color control unit controls a color output of the plurality of light-emitting diodes.

8. The method of claim 7, wherein the color control unit is programmed to provide a plurality of different color pattern outputs in the plurality of light-emitting diodes for creating a plurality of different underwater color displays in the underwater environment.

9. The method of claim 1, wherein the plurality of light-emitting diodes begin to flash on and off under poor lighting conditions.

10. The method of claim 1, wherein the control circuit board box includes an application-specific integrated circuit to control functioning of the pump and the plurality of light-emitting diodes.

11. The method of claim 1, wherein the cell box includes one or more battery cells for electrical power storage and for electrical power output, and wherein the cell box supplies electrical power to the pump and the plurality of light-emitting diodes during periods of no light and poor lighting conditions and when an output voltage of the solar panel apparatus is lower than a battery cell voltage in the cell box, and wherein the solar panel apparatus supplies the electrical power to the pump and the plurality of light-emitting diodes and charges the one or more battery cells contained within the cell box during periods of adequate lighting conditions and when the output voltage of the solar panel apparatus is higher than the battery cell voltage in cell box.

12. A solar panel water pump assembly, comprising:
a support base;
a solar panel apparatus that includes a plurality of light-emitting diodes that is attached to a support base;
a battery cell box and a control circuit board box that are attached to a bottom side of the support base that are electrically coupled to the solar panel apparatus;
a water conduit adapter that is inserted through the solar panel apparatus and the support base via an aperture;
a pump that includes a water outlet that is mechanically connected to the water conduit adapter and inserted through the solar panel apparatus and support base to form the solar panel water pump assembly;
electrical connectors that electrically couple the pump to the control circuit board box; and
a water display that includes an underwater environment that is equipped with the solar panel water pump assembly.

13. The solar panel water pump assembly of claim 12, wherein the solar panel apparatus includes a plurality of solar panels.

14. The solar panel water pump assembly of claim 12, wherein the solar panel apparatus includes a light sensor.

15. The solar panel water pump assembly of claim 12, wherein the solar panel apparatus creates a multi-colored display in the underwater environment.

16. The solar panel water pump assembly of claim 14, wherein the plurality of light-emitting diodes and the light sensor are assembled on a circuit board attached to the solar panel apparatus.

17. The solar panel water pump assembly of claim 14, wherein the light sensor controls on/off functioning of the plurality of light-emitting diodes according to current light conditions.

18. The solar panel water pump assembly of claim 12, wherein a color control unit controls a color output of the plurality of light-emitting diodes, and wherein the color control unit is programmed to provide a plurality of different color pattern outputs in the plurality of light-emitting diodes for creating a plurality of different underwater color displays in the underwater environment.

19. The solar panel water pump assembly of claim 12, wherein the control circuit board box includes an application-specific integrated circuit to control functioning of the pump and the plurality of light-emitting diodes.

20. The solar panel water pump assembly of claim 12, wherein the cell box includes one or more battery cells for electrical power storage and for electrical power output, and wherein the cell box supplies electrical power to the pump and the plurality of light-emitting diodes during periods of no light and poor lighting conditions and when an output voltage of the solar panel apparatus is lower than a battery cell voltage in the cell box, and wherein the solar panel apparatus supplies the electrical power to the pump and the plurality of light-emitting diodes and charges the one or more battery cells contained within the cell box during periods of adequate lighting conditions and when the output voltage of the solar panel apparatus is higher than the battery cell voltage in cell box.
